(19) United States
(12) Patent Application Publication
(10) Pub. No.: US 2023/0182333 A1
(43) Pub. Date: Jun. 15, 2023

(54) Shaving Razor with Cover Locking Arrangement

(71) Applicant: Leaf Shave Company, Pittsburgh, PA (US)

(72) Inventors: Adam J. Hahn, Pittsburgh, PA (US); Benjamin McCandless, Captain Cook, HI (US); Adam Simone, Mystic, CT (US)

(21) Appl. No.: 18/080,896

(22) Filed: Dec. 14, 2022

Related U.S. Application Data
(60) Provisional application No. 63/289,800, filed on Dec. 15, 2021.

(51) Int. Cl. B26B 21/22; B26B 21/30; B26B 21/40

(52) U.S. Cl. CPC B26B 21/227; B26B 21/30; B26B 21/4037; B26B 21/4062

(57) ABSTRACT

A shaving razor, including: a handle; a head pivotally attached to the handle, the head including a frame and a cover pivotally attached to the frame; and at least one locking feature positioned on the frame which fixes and releases the cover from the head, where the at least one locking feature is configured to move between at least two different positions, where in a first position the at least one locking feature engages with the cover to secure the cover to the frame and in a second position, the at least one locking feature is disengaged from the cover, the cover to rotatable away from the frame.

### CROSS-REFERENCE TO RELATED APPLICATION

This application claims priority to U.S. Provisional Application No. 63/289,800 filed Dec. 15, 2021, the disclosures of which are hereby incorporated by reference in their entirety.

### BACKGROUND OF THE INVENTION

### Field of the Invention

This disclosure relates generally to shaving razors and, more particularly, to a shaving razor with a pivoting head and cover locking arrangement.

### Description of Related Art

Razors have become ubiquitous and are used by both men and women for their personal shaving needs. Straight-blade razors, which are made of high carbon or stainless steel, exemplify the early modern popular style of shaving implements. Current shaving implements commonly consist of a handle and disposable razor cartridge. These razor cartridges can be used for many shaving sessions over a period of time, but must be thrown out after they become dull from use. The process of recycling these razor cartridges is tedious as there are multiple plastic and metal components that make up the traditional razor cartridge.

Disposable razor cartridges replaced the straight edge in popularity in the early part of the twentieth century. The disposal of blades after limited use was made popular and economical by the arrival of blades made of low-cost, thin steel, thereby eliminating the need for stropping or honing. The safety feature of these razors, protecting the user from all but the very edge of the blade, appealed to the user. The orientation of the handle and the blade required the user to develop the proper technique to achieve an optimal shave. The next evolution combined the safety of small, thin blades exposed only at the edge with the proper angle-of-attack and a pivoting head to adjust to the contours of the body. The disposable razor embodied the ease and simplicity of shaving, sacrificing longevity of product by providing disposable blades with limited life. This incarnation of men's and women's personal shavers remains the most popular and widely used, contributing a sizeable global economic impact.

While the convenience and ease of use of current disposable razor cartridge technology is attractive to users, alternative razors using partially replaceable blades have continued to evolve. However, current replaceable blades still are problematic and unsafe when being replaced. Current replaceable blades point the exposed blade toward the user when replacing and include awkward components which make replacing blades difficult.

Many of the current disposable razors end up in landfills or as trash impacting the global environment. Many of these disposed of razor cartridges, however, include components that do not need to be disposed of as they are still useable. This lead to a tremendous amount of unnecessary waste as only the dull razor blade needs to be replaced in the razor cartridge. Many of the components are replaceable, but are not easily removable to encourage or allow replacement. Therefore, there is an ongoing need to reduce the amount of waste contributed by useable components of razor cartridges and a need for easily replaceable components, which is accomplished by the razor cartridge described herein.

### SUMMARY OF THE INVENTION

In view of the foregoing, a need exists for a razor cartridge including a replaceable razor blade that provides an effective method of replacing the razor blades. A further need exists for a razor including an adjustable frame that provides a secure and easily removable cover for holding the razor blades.

In accordance with one aspect of the disclosure a shaving razor, the shaving razor has: a handle; a head pivotally attached to the handle, the head including a frame and a cover pivotally attached to the frame; and at least one locking feature positioned on the frame which fixes and releases the cover from the head, where the at least one locking feature is configured to move between at least two different positions, where in a first position the at least one locking feature engages with the cover to secure the cover to the frame and in a second position, the at least one locking feature is disengaged from the cover, the cover to rotatable away from the frame.

In accordance with one aspect of the disclosure the shaving razor has at least one separation member and the cover is pivotally attached to the head at a same point on the frame.

In accordance with one aspect of the disclosure the shaving razor has at least one separation member and the cover is pivotally attached to the head on the frame.

In accordance with one aspect of the disclosure of the shaving razor, the at least one separation member is configured to releasably fix a razor blade.

In accordance with one aspect of the disclosure of the shaving razor, the cover includes a cut out, the cut out configured to expose the at least one locking feature.

In accordance with one aspect of the disclosure of the shaving razor, an underside of the cover is configured to releaseably fix a razor blade by contacting at least a portion of the at least one separation member.

In accordance with one aspect of the disclosure of the shaving razor, a spring is configured to releaseably fix a razor blade.

In accordance with one aspect of the disclosure of the shaving razor, the cover and the at least one separation member are configured to expose a cutting edge of at least one razor blade.

In accordance with one aspect of the disclosure of the shaving razor, a grip member configured to contact a razor blade, the grip member embedded in the frame.

In accordance with one aspect of the disclosure of the shaving razor, the frame is configured to expose a non-cutting side of a razor blade.

In accordance with one aspect of the disclosure of the shaving razor, the shaving razor includes: a handle; a head attached to the handle, the head including a frame, a separation member pivotally attached to the frame and a cover pivotally attached to the frame; and at least one locking feature positioned on the frame which fixes and releases the cover from the head, where the locking feature is configured to move between at least two different positions, where in a first position the at least one locking feature engages with the cover to secure the cover to the frame and in a second position, the at least one locking feature is disengaged from the cover to permit the cover to rotate away from the frame; where in the first position the separation member is in between the cover and the frame.

In accordance with one aspect of the disclosure of the shaving razor, the separation member and the cover are pivotally attached to the head on the frame.

In accordance with one aspect of the disclosure of the shaving razor, the cover includes a cut out, the cut out configured to expose the at least one locking feature.

In accordance with one aspect of the disclosure of the shaving razor, the separation member includes at least one cover blade seat and at least one razor stop extrude, the at least cover blade seat and at least one razor stop extrude are configured to releasably fix a razor blade.

In accordance with one aspect of the disclosure of the shaving razor, an underside of the cover comprises at least one razor stop extrude receiver, the at least one razor stop extrude receiver is configured to releaseably fix the razor blade.

In accordance with one aspect of the disclosure of the shaving razor, a spring fixed to the frame, the spring configured to releaseably fix a razor.

In accordance with one aspect of the disclosure of the shaving razor, the cover and the at least one separation member are configured to expose a cutting edge of at least one razor blade.

In accordance with one aspect of the disclosure of the shaving razor, a grip member configured to contact a razor blade, the grip member embedded in the frame.

In accordance with one aspect of the disclosure of the shaving razor, the frame is configured to expose a non-cutting side of a razor blade.

In accordance with one aspect of the disclosure a shaving razor, includes: a handle; a head attached to the handle, the head including a frame, a separation member pivotally attached to the frame and a cover pivotally attached to the frame, the separation member includes at least one cover blade seat and at least one razor stop extrude, the at least cover blade seat and at least one razor stop extrude are configured to releasably fix a razor blade and an underside of the cover includes at least one razor stop extrude receiver, the at least one razor stop extrude receiver is configured to releaseably fix the razor blade; and at least one locking feature positioned on the frame which fixes and releases the cover from the head, where the locking feature is configured to move between at least two different positions, where in a first position the at least one locking feature engages with the cover to secure the cover to the frame and in a second position, the at least one locking feature is disengaged from the cover to permit the cover to rotate away from the frame; where in the first position the separation member is inbetween the cover and the frame.

Further details and advantages will be understood from the following detailed description read in conjunction with the accompanying drawings.

### BRIEF DESCRIPTION OF THE DRAWINGS

FIG. 1 is a front view of the razor according to one non-limiting embodiment or aspect of the present disclosure;

FIG. 2 is a side view of the razor of FIG. 1;

FIG. 3a is a rear view of the razor with the lock engaged of FIG. 1;

FIG. 3b is a rear view of an alternative embodiment of the razor with the lock engaged;

FIG. 4 is an isometric view of the razor head with the lock engaged of the razor of FIG. 1;

FIG. 5 is a side view of the razor head of FIG. 4;

FIG. 6 is an isometric view of the razor head of FIG. 4 with the lock disengaged;

FIG. 7 is a side view of the razor head of FIG. 4 with the lock disengaged;

FIG. 8 is an isometric view of the razor head of FIG. 4 with the cover in an open position;

FIG. 9 is a side view of the razor head of FIG. 4 with the cover in an open position;

FIG. 10 is an isometric view of the razor head of FIG. 4 with the separation member in an open position;

FIG. 11 is a side view of the razor head of FIG. 4 with the filler in an open position;

FIG. 12 is an isometric view of the razor head of FIG. 4 with a lower blade;

FIG. 13 is an isometric view of the razor head of FIG. 4 with the filler in a closed position;

FIG. 14 is an isometric view of the razor head of FIG. 4 with an upper blade;

FIG. 15 is an isometric cross sectional view of the razor head of FIG. 4;

FIG. 16 is a side cross sectional view of the razor head of FIG. 4;

FIG. 17 is an isometric view of the razor head with the razors; and

FIG. 18 is a bottom view of the razor head with a spring.

### DESCRIPTION OF THE INVENTION

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Embodiments of the present disclosure relate to a partially replaceable styling and grooming razor used for removing unwanted body hair in common, hard-to-reach, or awkward places. Additionally, the razor of these embodiments can be adjusted and used for shaving with a high degree of detail for safety and ornamental shaving. For example, the razor blade in the razor head can be safely replaced and recycled and could be used to groom the eyebrows, moustache, nose, sideburns, scalp, abdomen, bikini area, toes and other parts of the body. Certain embodiments are able to accomplish such effects because the size of the razor blades are very small in comparison to conventional razor blades and because the razor design allows for replacement of the razor in the razor head with the cutting edge away from the installer. In some embodiments, the blades are 1 inch, ½ inch, ⅜ inch, ¼ inch, ⅛ inch or any size or range of sizes in between any of these sizes in length, depth, or thickness. In another embodiment, the blades are 14 mm by 10 mm with a blade edge that is 37 mm in length. The blades may be any common size for a razor blade used, in general, as a shaving razor. Furthermore, in certain embodiments, each of the different size blades or heads can be used as interchangeable razors on the same razor handle, and can have single or multiple cutting edges.

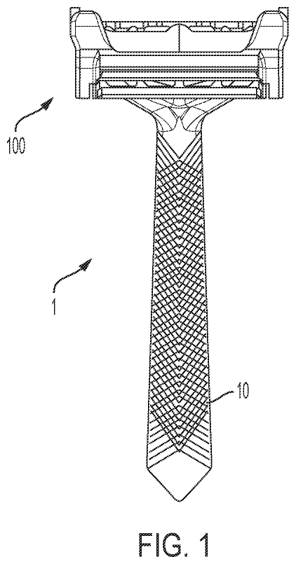

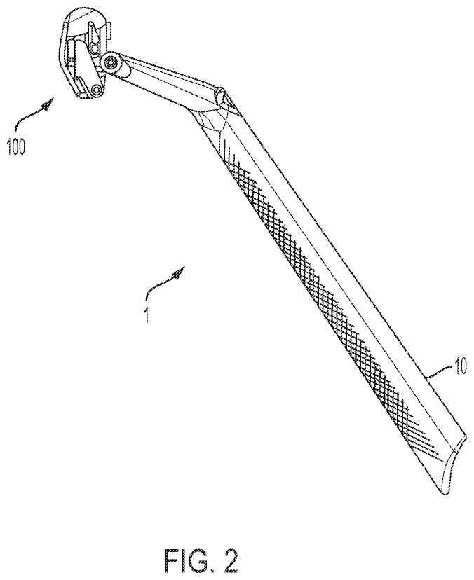

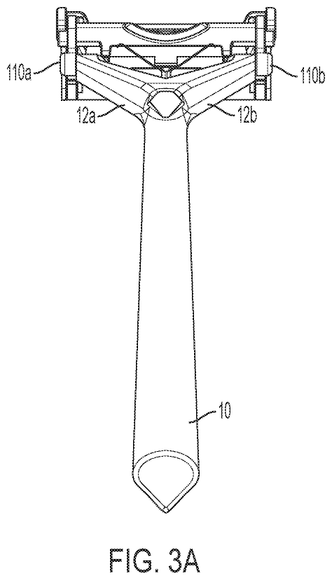

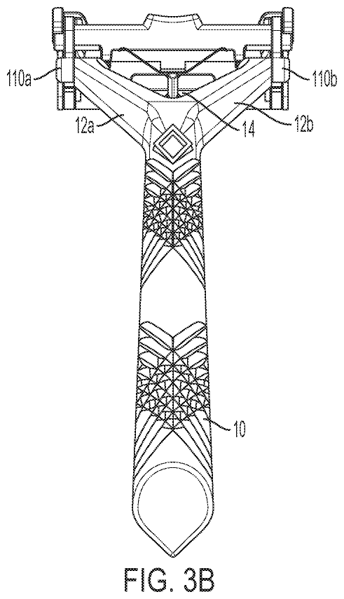

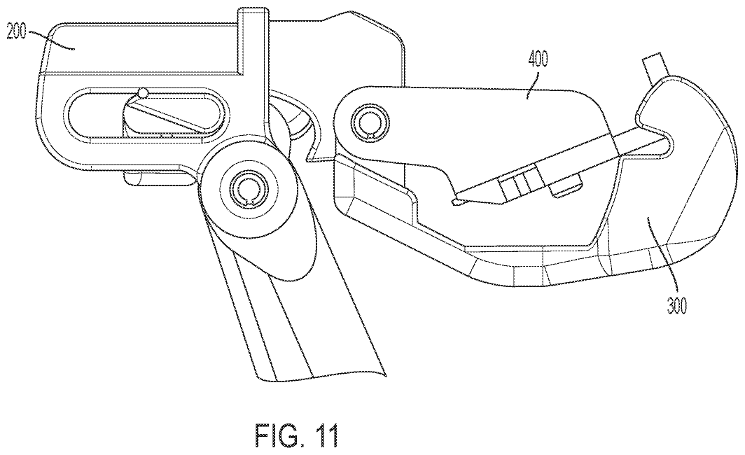

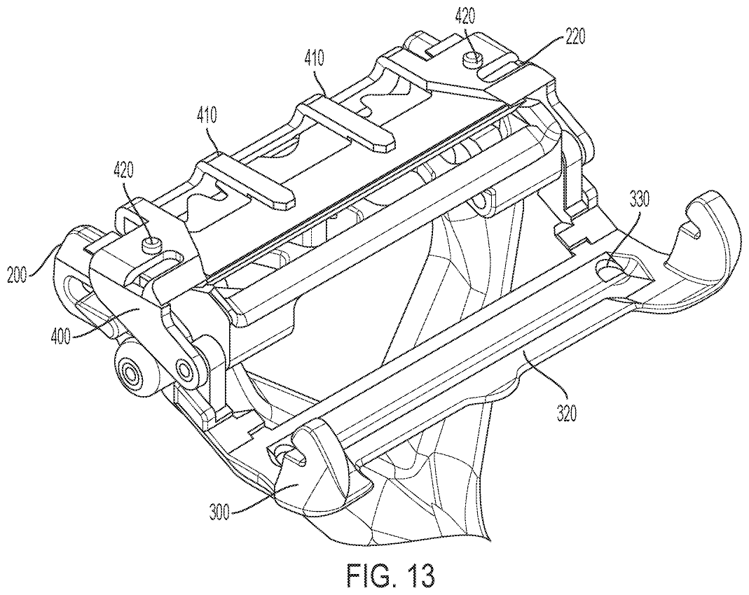

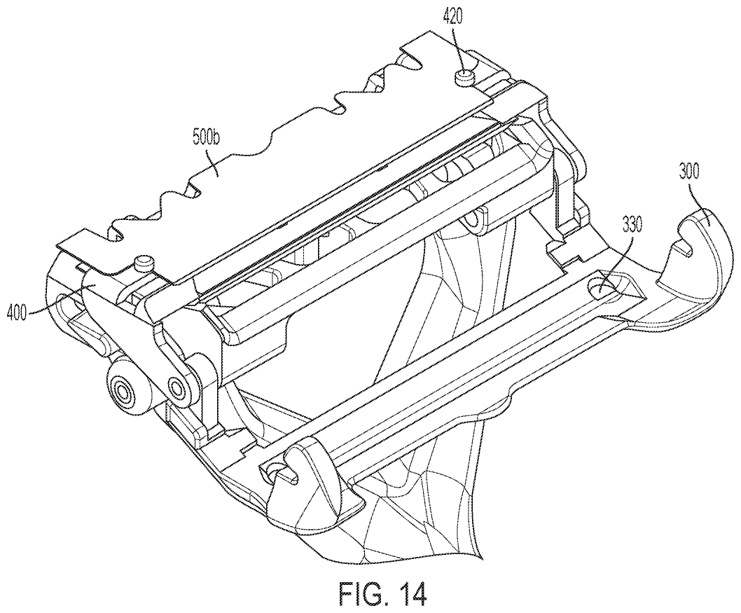

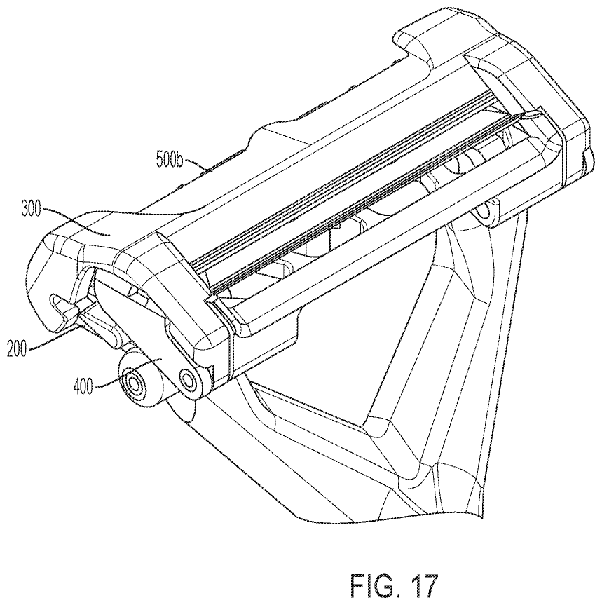

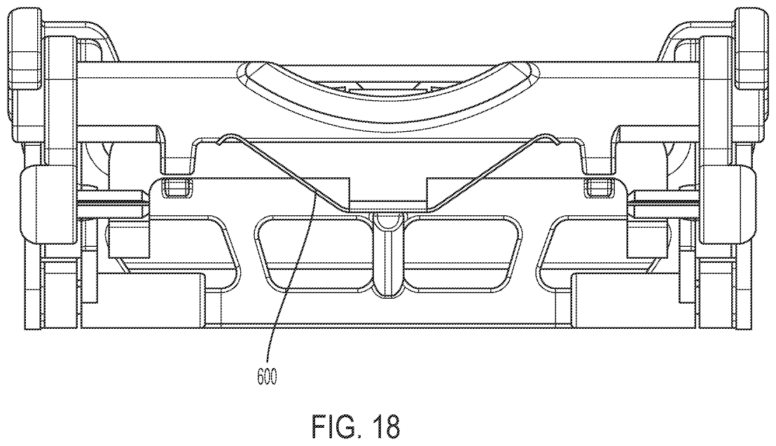

The present disclosure is directed to, in general, a shaving razor and, in particular, a shaving razor with safely replaceable razors. Certain preferred and non-limiting aspects of the components of the razor are illustrated in FIGS. 1-18.

With reference to FIGS. 1-4, one aspect of a shaving razor 1 is described. The razor 1 may include a handle 10 and a head 100. In one aspect, the head 100 may be pivotable or rotatable relative to or about the handle 10, as described herein below. The head 100 may have a substantially rectangular shape. In one aspect, the head 100 may have a substantially triangular shape, circular, oval, square, or trapezoidal. The head 100 may be rotatably fixed to the distal end of the handle 10. The distal end of the handle 10 may be understood to be the end of the handle 10 that is not held by a user during use of the razor device. The handle 10 may include a first extension member 12a and a second extension member 12b. The first and second extension members 12a, 12b may extend from a distal end of the handle 10. The first and second extension members 12a, 12b may define an aperture 14 there between. It is also contemplated that the aperture 14 may not be defined by the first and second extension members 12a, 12b, and the handle 10 may be formed as a single monolithic structure. The handle 10 may include different types of surfaces, including small protrusions, bumps, waves, or indentations, to provide a comforting ergonomic feel when held by an individual.

The head 100 may be positioned on the distal end of the first and second extension members 12a, 12b. In one aspect, the head 100 may be attached to the first and second extension members 12a, 12b by pins 110a, 110b. The pins 110a, 110b may be provided in apertures defined in the distal ends of the first and second extension members 12a,12b and may allow the head 100 to freely rotate and/or pivot about the handle 10. In one aspect, separate pins 110a, 110b may be inserted through each extension member 12a, 12b. In another aspect, the head 100 may be attached to the first and second extension members 12a, 12b by a single pin (not shown). The head 100 may be fixed to the handle 10 in a non-rotatable manner

By permitting rotation or pivoting of the head 100 relative to the handle 10, the razor 1 may be configured to set the blade and/or blades at the correct angle when pressure is applied to a shaving area. It is also contemplated that the head 100 may be spring-loaded on the handle 10 so the head 100 is returned to a resting position after being rotated relative to the handle 10.

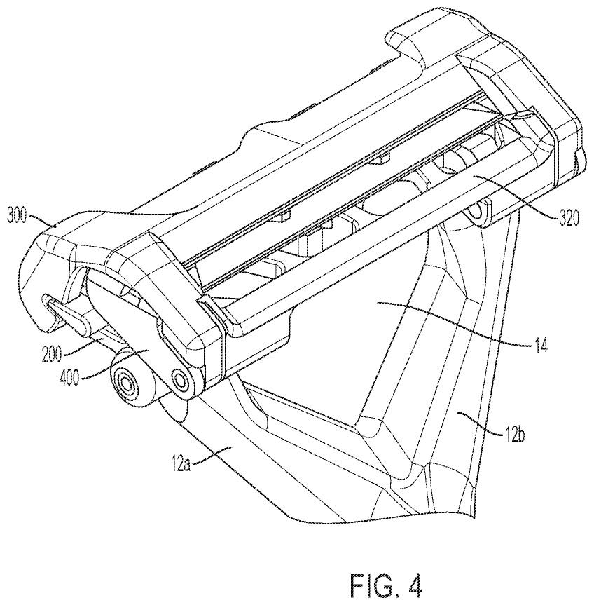

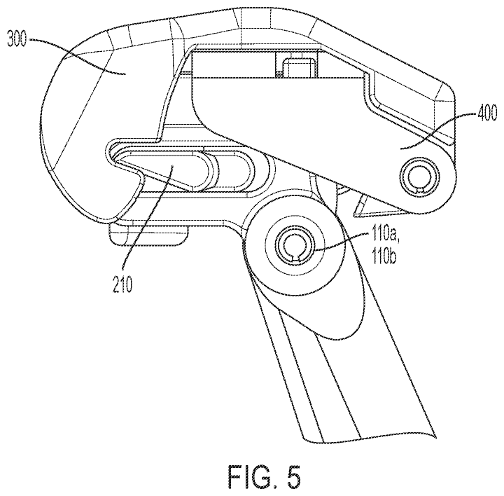

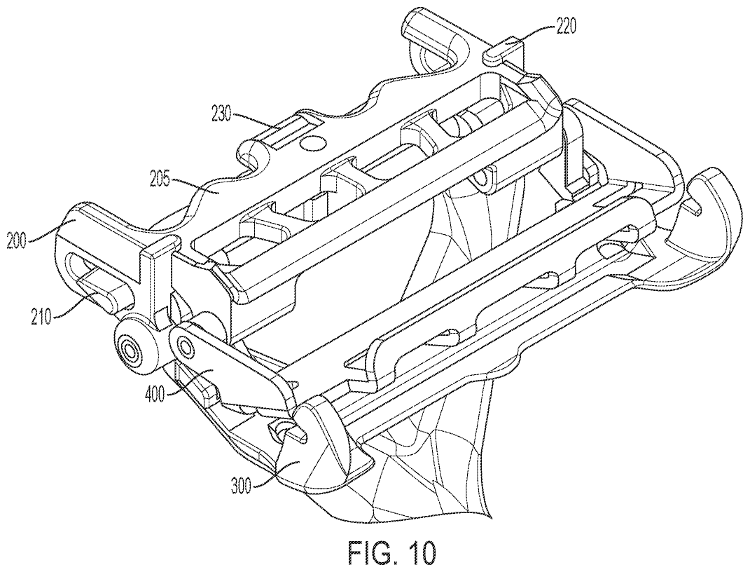

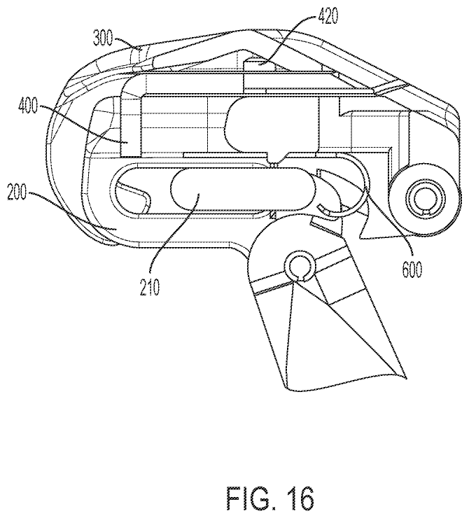

With reference to FIGS. 4 and 5, the head 100 may include a frame 200 and a cover 300. The cover may be any shape, but is preferably shaped for ease of the user when shaving. The frame 200 and cover 300 may be separated by a separating member 400. The frame 200 may be attached to the first and second extension members 12a, 12b via pins 110a, 110b. By connecting the frame 200 to the extension members 12a, 12b, the frame 200 may also be rotated and/or pivoted about the handle 10. The cover 300 and separating member 400 may be rotatably connected to the frame 200 at the same fixation point or different. The frame 200 and cover 300 may include a cross bar 320 or be configured to hold together two blades 500a, 500b in the head 100. The frame 200 may also include a grip portion 230, as shown in FIG. 10, for gripping a blade 500a, 500b, when inserted. The grip portion 230 and the cover 300 may be configured to expose a non cutting side of razor blade 500a, 500b for ergonomically aiding the user in installation of the razor blade 500a, 500b. It is also contemplated that the frame 200 and cover 300 may hold one blade or more than two blades in the head 100. In one aspect, the blades 500a, 500b may be formed from a double-edged razor blade 500a. An example of such a double-edged razor blade 500a, 500b is shown in FIG. 16. As used herein, the “shaving edge” or like terms of the razors of the present disclosure refers to a leading surface or portion of the head 100, such that, when in use, the shaving edge is followed by the exposed razor edges that contact a user's skin. Other embodiments of razor blades (single-edged and double-edged) with various perimeter profiles and/or central cut-out profiles are encompassed within the present disclosure. Presently, many manufacturers make these types of double-edged razor blades that use a standardized shape to fit in traditional safety razors.

In one aspect, the blades 500a, 500b of the razor 1 may be this type of double-edged blade. By “weak and thin”, it is meant that the blades are typically designed so that an individual can break a double-edged razor blade in half by hand, splitting along a centerline of profile cut-out. By breaking the double-edged razor blades in half, two “half blades” or two halves of the double-edged razor blade are provided. Each half may include one razor edge. It is also to be understood that the “half blades” may be provided in this initial form, without the need for breaking a double-edged razor blade in half by using the “half blades” in the head 10, the razor 1 may provide a multi-razor blade configuration for shaving an individual's face. While it is contemplated that any type of double-edged razor blade may be used with the razor 1, it is also contemplated that specific “half blades” may be designed and configured to custom fit in the frame 200 and cover 300 of the head 100.

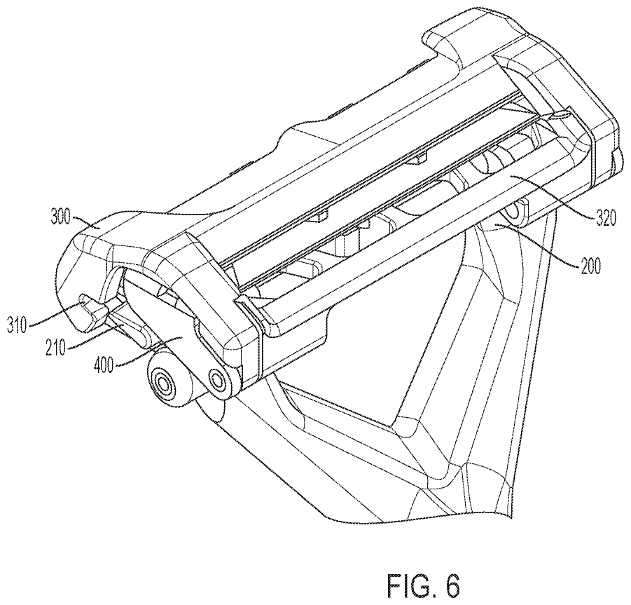

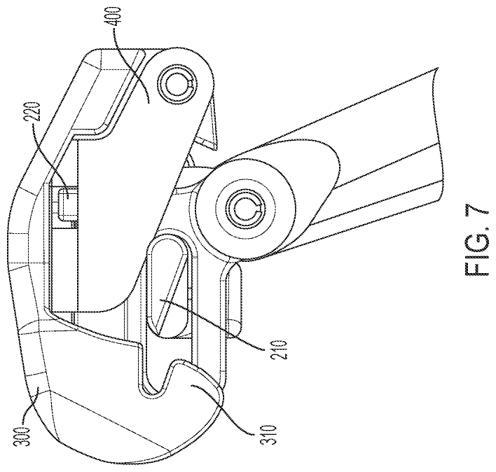

With reference to FIGS. 6 and 7, at least one locking mechanism 210 is located on the side of the frame 200 visible through the cut out 310 of the cover 300. The cover 300 may include a cut out 310 or be configured for ease of access to the lock 210. The cut out 310 may be any shape or size, but are preferably configured to the shape of the lock 210. The locking mechanism 210 may be located on another portion of the frame 200. The locking mechanism 210 may be any locking means. In this aspect, the locking mechanism 210 is a pin which secures and releases the cover 300 from the frame 200. After the blades 500a, 500b are installed, as described herein below, the cover 300 may be rotated and/or pivoted to the closed position to retain the blades 500a, 500b in the head 100. After the cover 300 has been moved to the closed position, the locking mechanism 210 may be used to lock and/or tighten the cover 300 to the frame 200 to hold the blades 500a, 500b therein. In another aspect, the locking mechanism 210 may include a spring-biased pin extending from the frame 200 with a spring action which includes a snap-fit arrangement or a clamping mechanism, among other locking mechanisms that could hold the frame 200 and cover 300 together. In another aspect, a magnetic locking mechanism may be used with the razor 1 to hold the frame 200 and the cover 300 to one another. The frame 200 may include an extrude 230 which is exposed through the separation member 400 and cover 300 while in the locked position.

The spring-based pin may act as a stopper or bolt to prevent the cover 300 from releasing form the frame 200. When the blades 500a, 500b are to be replaced, the pin or locking mechanism 210 may be pushed back to allow the cover 300 to open. When the cover 300 is being shut, the cover 300 presses against the pin pushing it back and then springing into a locked position against the cover 300 when the cover 300 is in the locked position. The shapes of the pin and portion of the cover 300 which engages with the pin are shaped to properly mate allowing the pin to spring into a locked position when the cover 300 is in the locked position.

In the locked position, the lock 210 prevents the cover 300 from disengaging from and/or rotating relative to the frame 200. In this aspect, the cover 300 may not be rotated or engaged into an open position so that the cover 300 and frame 200 secure the blades 500a, 500b.

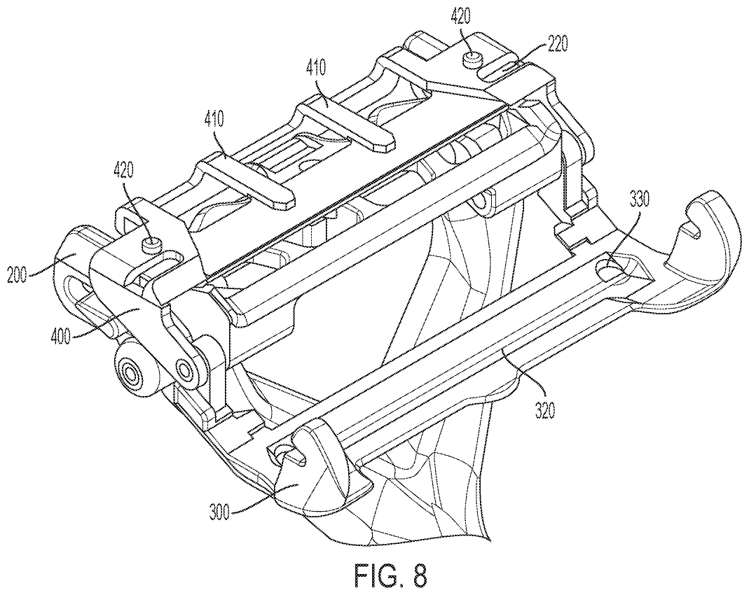

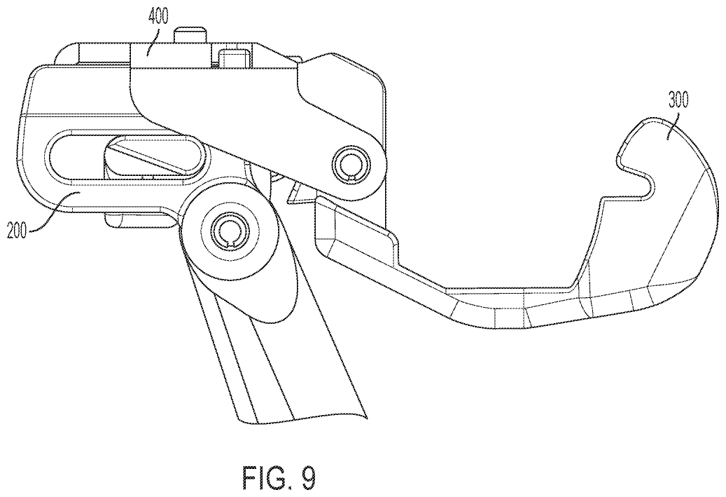

With reference to FIGS. 8 and 9, the cover 300 may be configured in at least two positions, including an open position and a closed position. In the open position, the lock 210 is disengaged and the cover 300 may be rotated relative to the frame 200 to allow for the removal and replacement of the blades 500a, 500b in the head 100. In the closed position, the cover 300 may be positioned on top of the frame 200 to retain the blades 500a, 500b in the head 100. In another aspect, the cover 300 may slide from the open position to the closed position. In the open position, the lock 210 is disengaged and the cover 300 may be slid relative to the frame 200 to allow for the removal and replacement of the blades 500a, 500b in the head 100.

With reference to FIGS. 8-13, a separation member 400 may also be provided in the head 100. The separation member 400 may be configured to separate the blades 500a, 500b from each other in the head 100. In one aspect, the separation member 400 may be positioned between the blades 500a, 500b when the blades 500a, 500b are retained in the head 100. The separation member 400 may be rotatably attached to the frame 200 and positioned within and between the frame 200 and the cover 300. The separation member 400 may be rotatable and/or pilotable relative to the frame 200 and cover 300. The separation member 400 may be rotatably attached to the frame 200 at the same pivotable location as the cover 300 or separately with an independent pivotable location. The separation member 400 may be configured to releasably fix razor blades 500a, 500b and may include at least one cover blade seat 410, but preferably two. The cover blade seat 410 is configured to aid in holding the razor blades 500a, 500b in place when in the locked position. The separation member 400 may include at least one blade stop 420, but preferably two. The blade stops 420 also are configured to aid in holding the razor blades 500a, 500b in place when in the locked position. The blade stops 420 may contact the cover 300 when in the locked or closed position, preferably the blade stops 420 contact a razor stop extrude receiver 330. The razor stop extrude receiver 330 may be a well or embedded section of the underside of the cover 300 inbetween the crossbar 320.

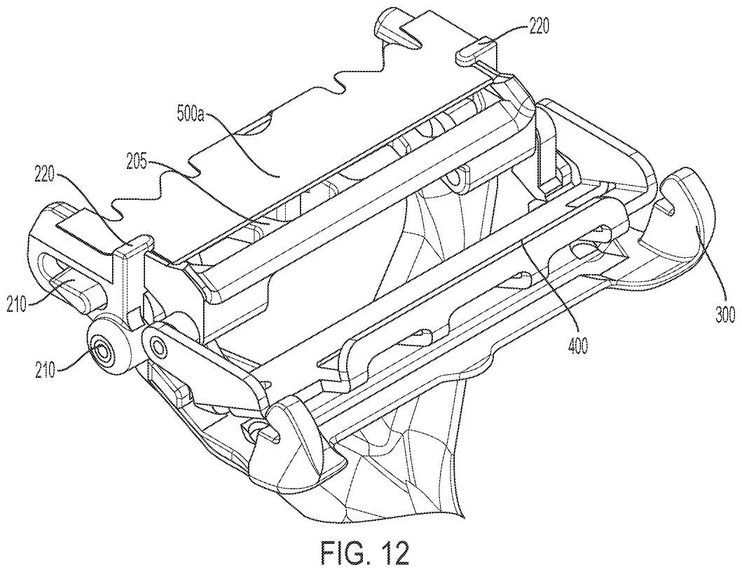

With reference to FIGS. 12-17, a bottom blade seat 205 may protrude or extend from the surface of the frame 200. The bottom blade seat 205 may be an integral extension of the frame 200 so that the bottom blade seat 205 is rotatable about the handle 10. It is also contemplated that the bottom blade seat 205 may be a separate component from the frame 200, which is separately rotatable about the handle 10. The bottom blade seat 205 may be designed to hold the blade 500a, 500b against the frame 200 with the cutting edge of the blade 500a, 500b exposed. The bottom blade seat 205 may be configured to allow the blade 500a, 500b to engagingly or releasably slide in with the cutting edge facing away from the installer. The advantage of this configuration allows for an increase in safety to the installer. The bottom blade seat 205 may also include magnets or another securing means to secure the blade 500a, 500b against the blade seat 205.

The separation member 400 may separate the first blade 500a from the second blade 500b. The cover 300 may be configured to allow the blade 500a, 500b to seat against the cover 300. The cover 300 may allow the blade 500a, 500b to engagingly or releasably slide in with the cutting edge facing away from the installer. The advantage of this configuration allows for an increase in safety to the installer. The cover 300 may also include magnets or another securing means to secure the blade 500a, 500b against the cover.

The separation member 400 may be configured to allow the blade 500a, 500b to seat against the separation member 400. The separation member 400 may allow the blade 500a, 500b to engagingly or releasably slide in with the cutting edge facing away from the installer. The advantage of this configuration allows for an increase in safety to the installer. The separation member 400 may also include magnets or another securing means to secure the blade 500a, 500b against the cover.

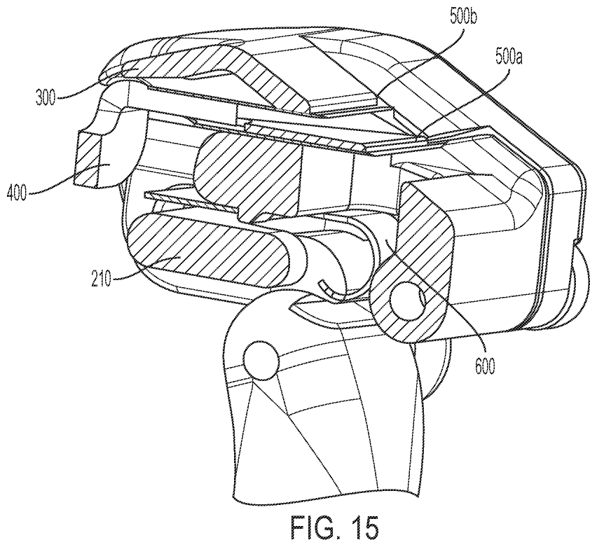

With reference to FIGS. 15-18, the head 100 may include a spring 600. The spring 600 is configured to force the head 100 into the resting or locked position. The resting position angles the installed blades 500a, 500b in a primed position for cutting the cutting surface. The spring 600 may actuate the lock 210 or a locking means to further releasably fix the blade 500a, 500b. Additional springs 600 may also be included to actuate the lock 210.

Other advantages and features of the invention will be apparent from the following description of particular embodiments and from the claims.

While aspects of a razor are shown in the accompanying figures and described hereinabove in detail, other aspects will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A shaving razor, comprising:
a handle;
a head pivotally attached to the handle, the head including a frame and a cover pivotally attached to the frame; and
at least one locking feature positioned on the frame which fixes and releases the cover from the head, wherein the at least one locking feature is configured to move between at least two different positions, wherein in a first position the at least one locking feature engages with the cover to secure the cover to the frame and in a second position, the at least one locking feature is disengaged from the cover, the cover to rotatable away from the frame.

2. The shaving razor of claim 1, wherein at least one separation member and the cover are pivotally attached to the head at a same point on the frame.

3. The shaving razor of claim 1, wherein at least one separation member and the cover are pivotally attached to the head on the frame.

4. The shaving razor of claim 3, wherein the at least one separation member is configured to releasably fix a razor blade.

5. The shaving razor of claim 1, wherein the cover comprises a cut out, the cut out configured to expose the at least one locking feature.

6. The shaving razor of claim 4, wherein an underside of the cover is configured to releaseably fix a razor blade by contacting at least a portion of the at least one separation member.

7. The shaving razor of claim 1, further comprising a spring configured to releaseably fix a razor blade.

8. The shaving razor of claim 3, wherein the cover and the at least one separation member are configured to expose a cutting edge of at least one razor blade.

9. The shaving razor of claim 1, further comprising a grip member configured to contact a razor blade, the grip member embedded in the frame.

10. The shaving razor of claim 1, wherein the frame is configured to expose a non-cutting side of a razor blade.

11. A shaving razor, comprising:
a handle;
a head attached to the handle, the head including a frame, a separation member pivotally attached to the frame and a cover pivotally attached to the frame; and
at least one locking feature positioned on the frame which fixes and releases the cover from the head, wherein the locking feature is configured to move between at least two different positions, wherein in a first position the at least one locking feature engages with the cover to secure the cover to the frame and in a second position, the at least one locking feature is disengaged from the cover to permit the cover to rotate away from the frame;
wherein in the first position the separation member is inbetween the cover and the frame

12. The shaving razor of claim 11, wherein the separation member and the cover are pivotally attached to the head on the frame.

13. The shaving razor of claim 11, wherein the cover comprises a cut out, the cut out configured to expose the at least one locking feature.

14. The shaving razor of claim 11, wherein the separation member comprises at least one blade seat and at least one razor stop extrude, the at least one blade seat and at least one razor stop extrude are configured to releasably fix a razor blade.

15. The shaving razor of claim 11, wherein an underside of the cover comprises at least one razor stop extrude receiver, the at least one razor stop extrude receiver is configured to releaseably fix the razor blade.

16. The shaving razor of claim 11, further comprising a spring fixed to the frame, the spring configured to releaseably fix a razor.

17. The shaving razor of claim 11, wherein the cover and the at least one separation member are configured to expose a cutting edge of at least one razor blade.

18. The shaving razor of claim 11, further comprising a grip member configured to contact a razor blade, the grip member embedded in the frame.

19. The shaving razor of claim 11, wherein the frame is configured to expose a non-cutting side of a razor blade.

20. A shaving razor, comprising:
a handle;
a head attached to the handle, the head including a frame having an extrude, a separation member pivotally attached to the frame and a cover pivotally attached to the frame, the separation member comprises at least one blade seat and at least one razor stop extrude, the at least one blade seat and at least one razor stop extrude are configured to releasably fix a razor blade and an underside of the cover comprises at least one razor stop extrude receiver, the at least one razor stop extrude receiver is configured to releaseably fix the razor blade; and
at least one locking feature positioned on the frame which fixes and releases the cover from the head, wherein the locking feature is configured to move between at least two different positions, wherein in a first position the at least one locking feature engages with the cover to secure the cover to the frame and in a second position, the at least one locking feature is disengaged from the cover to permit the cover to rotate away from the frame;
wherein in the first position the separation member is in between the cover and the frame.
